(19) United States
(12) Patent Application Publication
(10) Pub. No.: US 2025/0165849 A1
(43) Pub. Date: May 22, 2025

(54) SYSTEM FOR OPTIMIZING WORKFLOW MANAGEMENT AND RESPONSE SYSTEMS IN A DISTRIBUTED NETWORK USING AI

(71) Applicant: BANK OF AMERICA CORPORATION, Charlotte, NC (US)

(72) Inventors: Amer Ali, Jersey City, NJ (US); Pratap Dande, Saint Johns, FL (US); Sailesh Vezzu, Hillsborough, NJ (US); Rahul Shashidhar Phadnis, Charlotte, NC (US); Rahul Yaksh, Austin, TX (US); Hari Vuppala, Concord, NC (US); Elvis Nyamwange, Little Elm, TX (US); Brian Neal Jacobson, Los Angeles, CA (US); Erik Dahl, Newark, DE (US)

(73) Assignee: BANK OF AMERICA CORPORATION, Charlotte, NC (US)

(21) Appl. No.: 18/511,164

(22) Filed: Nov. 16, 2023

(51) Int. Cl. G06N 20/00; G06Q 10/10

(52) U.S. Cl. CPC G06N 20/00; G06Q 10/103

(57) ABSTRACT

Systems, computer program products, and methods are described herein for optimizing workflow management and response systems in a distributed network. The present disclosure is configured to integrate various enterprise systems, analyze workflow data for efficiency improvements, automate access management, and enhance task prioritization using advanced machine learning algorithms. Specifically, the system leverages real-time analytics and historical data to fine-tune workflows, predict delegation needs, and provide end-users with an actionable dashboard, thus streamlining operations and decision-making processes within an organization.

### TECHNOLOGICAL FIELD

Example embodiments of the present disclosure relate to optimizing workflow management and response systems in a distributed network.

### BACKGROUND

The advent of workflow management systems has revolutionized how large organizations manage internal processes, yet the challenge of coordinating actions across multiple systems remains. Traditionally, employees and managers navigate a labyrinth of platforms to perform essential tasks like approving access, addressing vulnerabilities, and reviewing potential issues. This multifaceted approach, often compounded by a reliance on email communications, is harmed by various inefficiencies. Moreover, the absence of a cohesive system to delegate tasks or understand access requirements for approvers contributes to operational delays, overlooked tasks, and increased potential for errors. The need for a centralized, streamlined process is evident to mitigate these inefficiencies and improve the overall workflow within complex organizational structures.

Applicant has identified a number of deficiencies and problems associated with optimizing workflow management and response systems in a distributed network. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for optimizing workflow management and response systems in a distributed network. To address the above problems and needs, the introduction of an optimized workflow system presents a transformative solution. Enhanced with artificial intelligence (AI), the system acts as a singular gateway to all organizational procedures, greatly simplifying the multi-system navigation that hinders conventional operations. The system grants the ability to design specific workflows, assign tasks with ease, and intelligently manage access requirements for approval processes. The AI component of the system not only facilitates the initial setup but also provides continuous monitoring and optimization of workflows, offering insights and recommendations for efficiency improvements. Its dynamic design capabilities, predictive delegation for task continuity, and advanced email analysis for prioritization allow for an improved and more efficient organizational task management. By integrating disparate systems and employing AI to prioritize and streamline tasks, the system enhances operational efficiency, preemptively addresses workflow interruptions, and maintain a steady course of productivity, even in the face of potential obstacles.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrate technical components of an exemplary distributed computing environment for optimizing workflow management and response systems in a distributed network, in accordance with an embodiment of the disclosure;

FIG. 2 illustrates an exemplary machine learning (ML) subsystem architecture 200 for optimizing workflow management and response systems in a distributed network, in accordance with an embodiment of the invention; and

FIG. 3 illustrates a process flow 200 for optimizing workflow management and response systems in a distributed network, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

In complex entity environments, large organizations grapple with the challenge of navigating a multitude of systems for routine operational tasks. The current workflow involves cumbersome processes where employees and managers approve access, address security vulnerabilities, and review assessments across disparate systems. Often, these tasks are communicated via email, a system that falls short in efficiency, leading to critical action items being overlooked in overflowing inboxes. The lack of a centralized task delegation mechanism and clarity on access management further exacerbates the problem, resulting in operational inefficiencies, task delays, and increased error margins.

The present system presents a solution to these pervasive challenges. It stands as a unified platform that consolidates all organizational actions into a single point of entry, thereby streamlining the multitude of tasks across various systems. Enhanced with artificial intelligence (AI), the system enables assignors to specify and tailor workflows for different processes and assignees. This centralized system is designed to be intuitive, allowing for seamless navigation and efficient management of workflow processes, which are traditionally scattered and disjointed. A cornerstone feature of the system is its unified interface with AI-prioritization, which provides a consolidated dashboard view. This interface aggregates action items from multiple systems and employs AI to prioritize tasks based on urgency and importance. This strategic prioritization is essential, ensuring that critical tasks are highlighted and addressed promptly, eliminating the inefficiency of logging into multiple systems.

A dynamic flow designer within the system allows for the visual creation and definition of workflows, promoting flexibility and customization. The embedded AI analyzes historical data and organizational patterns to recommend the most effective workflow designs. This feature is pivotal in ensuring that workflows are not only functional but also optimized for the specific needs of the organization. Addressing the need for effective task delegation, the system introduces a proxy assignment module with predictive delegation. The AI within this system anticipates potential delays or periods of unavailability, such as employee vacations, and proactively suggests delegation of tasks to prevent workflow interruptions. This predictive approach ensures that operations continue smoothly, even in the absence of key personnel.

Automated access management is another key innovation of the system. By utilizing AI, the system intelligently identifies and manages the access rights required by approvers, thus facilitating a more streamlined and expedited approval process. This automation reduces wait times for access and diminishes the likelihood of bottlenecks in the approval chain. It is important to note that the system is not static; it embodies a philosophy of continuous monitoring and optimization. The system consistently oversees all organizational processes and leverages AI-driven analytics to recommend enhancements. This ongoing scrutiny ensures that the workflows are maintained efficiently and remain agile to adapt to changing organizational needs.

Integration capabilities of the system are broad and flexible, with AI-matching ensuring that data from various platforms is accurately consolidated, even when faced with differing terminologies and data formats. Such integration is crucial for maintaining data integrity and providing a holistic view of organizational processes.

Lastly, the system revolutionizes how emails are managed with its email analysis and prioritization feature. The AI engine diligently examines incoming emails, identifying and extracting action items, and then prioritizes these within the dashboard interface. This ensures that urgent tasks are actioned appropriately and not lost in the sea of less critical communications. By adopting the AI-powered system, organizations are positioned to significantly boost their operational efficiency. This system reduces the reliance on manual processes, minimizes errors, foresees and mitigates potential process bottlenecks, and ensures that business processes are continuously refined and enhanced for peak productivity.

The system is a technologically advanced platform designed to centralize and streamline organizational processes. Enhanced by artificial intelligence (AI), it simplifies the way large organizations manage a myriad of operational tasks by consolidating them into a single, accessible system. In the realm of large organizations, the problem lies in the cumbersome nature of managing various operational tasks across multiple, disjointed systems. This often involves a series of time-consuming logins, prior access requests, and an overwhelming reliance on email communications for task management. The result is an inefficient process where important tasks can be easily missed or delayed, particularly when employees are faced with high email volumes or are away from work. In simple terms, the solution provides a solution akin a smart assistant that knows exactly what tasks a user needs to do, alerts the user which ones are the most important, and even handles menial tasks in order for the user to focus their time and energy on more critical work.

Accordingly, the present disclosure envisions a streamlined workflow system that intelligently organizes and prioritizes tasks through a single dashboard, designs flexible work processes, anticipates the need for task delegation, and manages access rights efficiently. It constantly monitors all activity to recommend improvements and integrates data from various systems seamlessly. Additionally, it sorts through emails to ensure important tasks are always available to the end user in an efficient manner.

What is more, the present disclosure provides a technical solution to a technical problem. As described herein, the technical problem includes the inefficient management of tasks across multiple systems within large organizations, leading to delays and errors. The technical solution presented herein allows for the centralized coordination of these tasks, prioritizing them in an intelligent manner and streamlining the approval processes. In particular, the SYSTEM is an improvement over existing solutions to the task management inefficiency problem, (i) with fewer steps to achieve the solution, thus reducing the amount of computing resources, such as processing resources, storage resources, network resources, and/or the like, that are being used, (ii) providing a more accurate solution to the problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

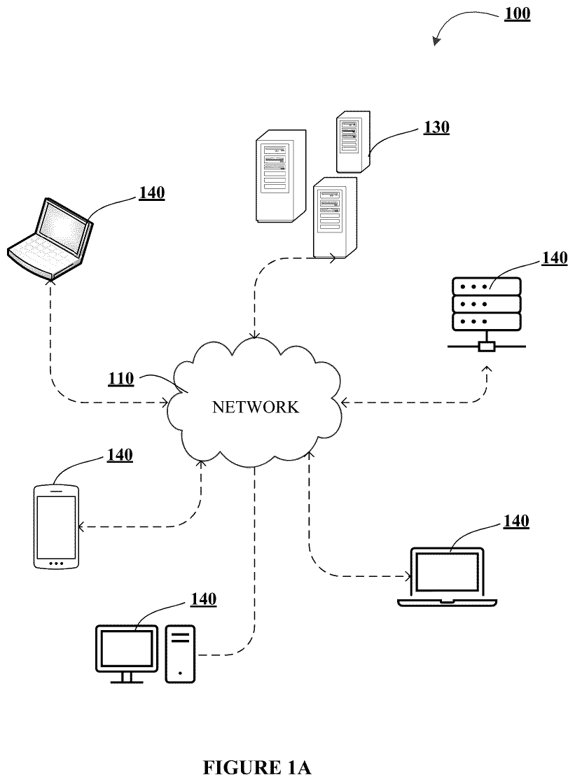

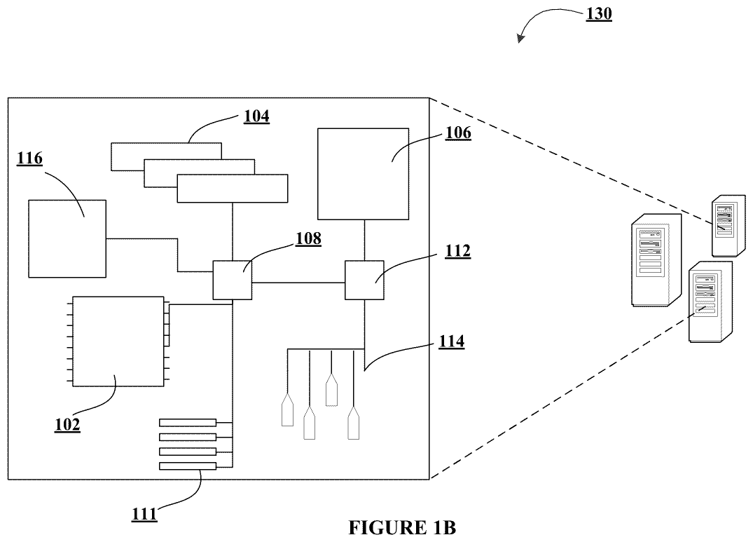

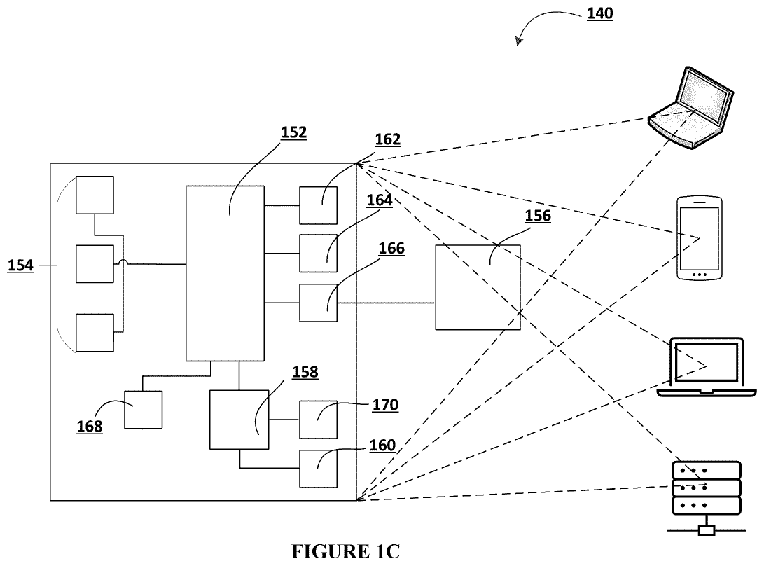

FIGS. 1A-1C illustrate technical components of an exemplary distributed computing environment 100 for optimizing workflow management and response systems in a distributed network, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer- or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation-and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

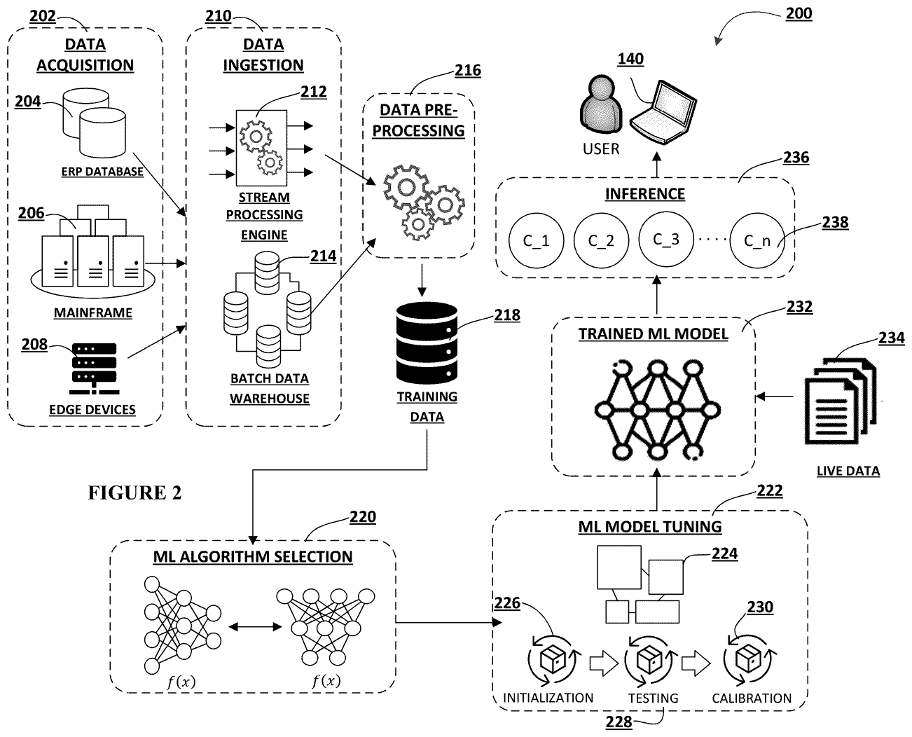

FIG. 2 illustrates an exemplary machine learning (ML) subsystem architecture 200, in accordance with an embodiment of the invention. The machine learning subsystem 200 may include a data acquisition engine 202, data ingestion engine 210, data pre-processing engine 216, ML model tuning engine 222, and inference engine 236. The architecture is specifically designed to facilitate incident response workflows by using AI to better anticipate access needs of certain users to access authorized databases and to channel incidents to relevant parties in an actionable manner.

The data acquisition engine 202 may identify various internal and/or external data sources to generate, test, and/or integrate new features for training the machine learning model 224. These internal and/or external data sources 204, 206, and 208 may be initial locations where the data originates or where physical information is first digitized. The data acquisition engine 202 may identify the location of the data and describe connection characteristics for access and retrieval of data. In some embodiments, data is transported from each data source 204, 206, or 208 using any applicable network protocols, such as the File Transfer Protocol (FTP), Hyper-Text Transfer Protocol (HTTP), or any of the myriad Application Programming Interfaces (APIs) provided by websites, networked applications, and other services. In some embodiments, the these data sources 204, 206, and 208 may include Enterprise Resource Planning (ERP) databases that host data related to day-to-day business activities such as accounting, procurement, project management, exposure management, supply chain operations, and/or the like, mainframe that is often the entity's central data processing center, edge devices that may be any piece of hardware, such as sensors, actuators, gadgets, appliances, or machines, that are programmed for certain applications and can transmit data over the internet or other networks, and/or the like. The data acquired by the data acquisition engine 202 from these data sources 204, 206, and 208 may then be transported to the data ingestion engine 210 for further processing. For incident response, these sources may include security event feeds, user activity logs, and access logs from critical systems. The acquired data is pivotal for training the ML model to recognize patterns indicative of incidents requiring immediate attention and access authorization needs.

Depending on the nature of the data imported from the data acquisition engine 202, the data ingestion engine 210 may move the data to a destination for storage or further analysis. Typically, the data imported from the data acquisition engine 202 may be in varying formats as they come from different sources, including RDBMS, other types of databases, S3 buckets, CSVs, or from streams. Since the data comes from different places, it needs to be cleansed and transformed so that it can be analyzed together with data from other sources. At the data ingestion engine 202, the data may be ingested in real-time, using the stream processing engine 212, in batches using the batch data warehouse 214, or a combination of both. The stream processing engine 212 may be used to process continuous data stream (e.g., data from edge devices), i.e., computing on data directly as it is received, and filter the incoming data to retain specific portions that are deemed useful by aggregating, analyzing, transforming, and ingesting the data. On the other hand, the batch data warehouse 214 collects and transfers data in batches according to scheduled intervals, trigger events, or any other logical ordering. This step is particularly critical for incident response as it involves real-time processing of data streams for immediate action and batch processing for analysis and learning.

In machine learning, the quality of data and the useful information that can be derived therefrom directly affects the ability of the machine learning model 224 to learn. The data pre-processing engine 216 may implement advanced integration and processing steps needed to prepare the data for machine learning execution. This may include modules to perform any upfront, data transformation to consolidate the data into alternate forms by changing the value, structure, or format of the data using generalization, normalization, attribute selection, and aggregation, data cleaning by filling missing values, smoothing the noisy data, resolving the inconsistency, and removing outliers, and/or any other encoding steps as needed. The data pre-processing engine 216 is thus tailored to refine the data for incident response, emphasizing the elimination of noise that could obscure incident detection and streamlining the data to highlight potential access control issues. The data pre-processing engine 216 also enhances the ML model's ability to anticipate which incidents should be routed to which parties. This is achieved by implementing feature extraction techniques that highlight the characteristics of incidents that typically require intervention from specific roles within the IT environment.

In addition to improving the quality of the data, the data pre-processing engine 216 may implement feature extraction and/or selection techniques to generate training data 218. Feature extraction and/or selection is a process of dimensionality reduction by which an initial set of data is reduced to more manageable groups for processing. A characteristic of these large data sets is a large number of variables that require a lot of computing resources to process. Feature extraction and/or selection may be used to select and/or combine variables into features, effectively reducing the amount of data that must be processed, while still accurately and completely describing the original data set. Depending on the type of machine learning algorithm being used, this training data 218 may require further enrichment. For example, in supervised learning, the training data is enriched using one or more meaningful and informative labels to provide context so a machine learning model can learn from it. For example, labels might indicate whether a photo contains a bird or car, which words were uttered in an audio recording, or if an x-ray contains a tumor. Data labeling is required for a variety of use cases including computer vision, natural language processing, and speech recognition. In contrast, unsupervised learning uses unlabeled data to find patterns in the data, such as inferences or clustering of data points.

The ML model tuning engine 222 may be used to train a machine learning model 224 using the training data 218 to make predictions or decisions without explicitly being programmed to do so. The model 224 is specifically configured to recognize the urgency and relevancy of different types of incidents and access requests. The machine learning model 224 represents what was learned by the selected machine learning algorithm 220 and represents the rules, numbers, and any other algorithm-specific data structures required for classification. Selecting the right machine learning algorithm may depend on a number of different factors, such as the problem statement and the kind of output needed, type and size of the data, the available computational time, number of features and observations in the data, and/or the like. Machine learning algorithms may refer to programs (math and logic) that are configured to self-adjust and perform better as they are exposed to more data. To this extent, machine learning algorithms are capable of adjusting their own parameters, given feedback on previous performance in making prediction about a dataset.

The machine learning algorithms contemplated, described, and/or used herein include supervised learning (e.g., using logistic regression, using back propagation neural networks, using random forests, decision trees, etc.), unsupervised learning (e.g., using an Apriori algorithm, using K-means clustering), semi-supervised learning, reinforcement learning (e.g., using a Q-learning algorithm, using temporal difference learning), and/or any other suitable machine learning model type. Each of these types of machine learning algorithms can implement any of one or more of a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a deep learning algorithm (e.g., a restricted Boltzmann machine, a deep belief network method, a convolution network method, a stacked auto-encoder method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or the like. These algorithms are crucial for the system, as they enable the system to learn from past incidents and to adapt to new, previously unseen security threats or irregular access patterns.

To tune the machine learning model, the ML model tuning engine 222 may repeatedly execute cycles of experimentation 226, testing 228, and tuning 230 to optimize the performance of the machine learning algorithm 220 and refine the results in preparation for deployment of those results for consumption or decision making. To this end, the ML model tuning engine 222 may dynamically vary hyperparameters each iteration (e.g., number of trees in a tree-based algorithm or the value of alpha in a linear algorithm), run the algorithm on the data again, then compare its performance on a validation set to determine which set of hyperparameters results in the most accurate model. The accuracy of the model is the measurement used to determine which set of hyperparameters is best at identifying relationships and patterns between variables in a dataset based on the input, or training data 218. A fully trained machine learning model 232 is one whose hyperparameters are tuned and model accuracy maximized. To optimize incident response, the ML model tuning engine 222 employs a rigorous training process. It involves simulating incident scenarios to refine the model's predictive capabilities, ensuring that incident alerts and access requirements are accurately identified and prioritized for response by the correct organizational roles.

The trained machine learning model 232, similar to any other software application output, can be persisted to storage, file, memory, or application, or looped back into the processing component to be reprocessed. Once trained, the machine learning model 232 is deployed to operationalize the anticipatory and actionable routing of incidents. More often, the trained machine learning model 232 is deployed into an existing production environment to make practical business decisions based on live data 234. To this end, the machine learning subsystem 200 uses the inference engine 236 to make such decisions. The inference engine 236 applies the model to live data 234, pushing incidents to the correct parties and facilitating the swift granting of access to authorized databases, thus streamlining incident responses.

The type of decision-making may depend upon the type of machine learning algorithm used. For example, machine learning models trained using supervised learning algorithms may be used to structure computations in terms of categorized outputs (e.g., C_1, C_2 . . . C_n 238) or observations based on defined classifications, represent possible solutions to a decision based on certain conditions, model complex relationships between inputs and outputs to find patterns in data or capture a statistical structure among variables with unknown relationships, and/or the like. On the other hand, machine learning models trained using unsupervised learning algorithms may be used to group (e.g., C_1, C_2 . . . C_n 238) live data 234 based on how similar they are to one another to solve exploratory challenges where little is known about the data, provide a description or label (e.g., C_1, C_2 . . . C_n 238) to live data 234, such as in classification, and/or the like. These categorized outputs, groups (clusters), or labels are then presented to the user input system 130. In still other cases, machine learning models that perform regression techniques may use live data 234 to predict or forecast continuous outcomes.

It will be understood that the embodiment of the machine learning subsystem 200 illustrated in FIG. 2 is exemplary and that other embodiments may vary. As another example, in some embodiments, the machine learning subsystem 200 may include more, fewer, or different components. This flexibility ensures that the system can be adapted to different IT environments and incident types, maintaining robust incident response capabilities across various organizational contexts.

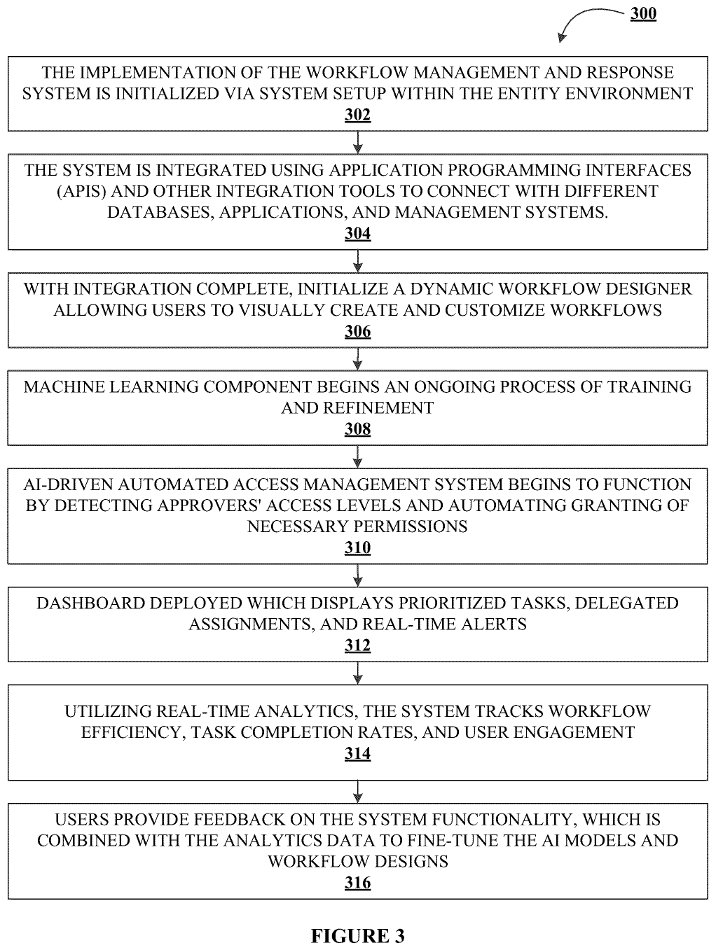

FIG. 3 illustrates a process flow 300 for optimizing workflow management and response systems in a distributed network, in accordance with an embodiment of the disclosure. The implementation of the system begins with the system setup within an entity environment, as indicated in block 302. This involves installing the system software on the organization's servers and configuring it to interface with the existing information technology (IT) infrastructure. The system employs advanced machine learning algorithms that require initial training data, which typically consists of historical workflow data, prior task prioritization, and access management records. This stage sets the foundation for the system to learn and adapt to the organization's unique operational needs.

In a preferred embodiment of the system, the initial setup process commences with the installation of the workflow management and response software on the organization's primary servers, which could be cloud-based, on-premises, or hybrid. This software package is comprised of various modules, including a central processing application, a database management system (DBMS), and an integration framework. The central processing application is responsible for orchestrating the workflow and could be built on a platform such as Java Enterprise Edition (JEE) for robust, scalable, and secure processing. The DBMS, preferably a SQL-based system like MySQL or PostgreSQL, is utilized to store and manage the workflow data, access permissions, and historical records that are essential for the machine learning models. The integration framework, which could be based on RESTful APIs or SOAP web services, ensures that the system can communicate with existing enterprise systems such as Enterprise Resource Planning (ERP), Customer Relationship Management (CRM), or other specialized software tools employed within the entity.

Once the software components are in place, the system is configured to align with the IT infrastructure. This involves setting up network configurations to enable seamless communication between the system and other systems within the entity's network. Secure connections, likely through Secure Sockets Layer (SSL) or Transport Layer Security (TLS), are established to ensure data integrity and security. The system is then primed with initial training data. This data is not only historical in nature but also includes current operational data streams to allow the machine learning algorithms to understand the real-time context of the entity's operations. The machine learning algorithms themselves could be based on a combination of supervised learning for known workflow patterns and unsupervised learning to detect and adapt to new, unforeseen operational behaviors. Tools like TensorFlow or PyTorch, could be employed to facilitate the development and operationalization of these algorithms.

In this preferred embodiment, after the system is initialized, a data acquisition layer is established. This layer is tasked with collecting data from the various sources within the entity's IT ecosystem. The collected data is then passed to a data pre-processing module where it is cleansed, normalized, and transformed into a uniform format suitable for analysis. A feature extraction process is applied to this pre-processed data to identify the most relevant attributes for the machine learning models. Once the system is fully configured and the initial machine learning models are trained with the pre-processed data, it undergoes a testing phase where it simulates various operational scenarios to ensure the models are accurately predicting and responding to the entity's workflows.

Other embodiments of the system are contemplated as well. For instance, in environments where real-time data processing is critical, an in-memory computing platform like Apache Spark could be integrated for faster data processing and analysis. Alternatively, for entities with less complex workflows or lower transaction volumes, a simpler machine learning setup with fewer features or less emphasis on real-time analytics could be implemented, potentially using lightweight ML libraries and smaller-scale database solutions. Regardless of the embodiment, the core objective remains the same: to facilitate a seamless, intelligent workflow management system that adapts to the unique operational needs of the entity.

Once the system is installed on entity servers, the next step is to integrate it with the organization's various systems and platforms, as indicated in block 304. The system uses application programming interfaces (APIs) and other integration tools to connect with different databases, applications, and management systems. This allows the system to pull and push data as needed, ensuring that all necessary information is available within the centralized workflow system. In the preferred embodiment, the integration phase is a critical juncture in the deployment of the system, aimed at establishing a cohesive operating environment. This is achieved by utilizing application programming interfaces (APIs) that act as conduits for data exchange between the workflow management and response system and the entity's diverse array of databases and applications. The APIs are designed to be RESTful, providing a stateless, client-server, cacheable communications protocol. These APIs facilitate the system's capability to issue requests to retrieve (GET), update (PUT), create (POST), and delete (DELETE) data across different systems, thus enabling a dynamic flow of information.

Moreover, the system incorporates middleware solutions that provide additional layers of integration, such as message queues for handling asynchronous communication and Enterprise Service Bus (ESB) for more complex data transformations and routing. For database connectivity, the system employs both JDBC (Java Database Connectivity) for relational databases and ODBC (Open Database Connectivity) for additional database systems that might be in use within the organization. This dual connectivity ensures that the system can interface with a wide range of database management systems, from MySQL and PostgreSQL to Microsoft SQL Server and Oracle databases.

The integration tools also encompass authentication and authorization mechanisms, ensuring secure and controlled access to data. OAuth 2.0 is commonly used for authorization, providing secure delegated access, while in other embodiments, OpenID Connect can be used for authentication. These security protocols are essential, particularly when integrating with systems that contain sensitive information or when the workflow involves access to privileged operations. To facilitate a smooth integration process, the system is equipped with a configuration management interface that allows system administrators to map data fields, define integration logic, and set up synchronization schedules. This interface is designed to be user-friendly, allowing non-technical staff to manage the integration settings with minimal training.

While the preferred embodiment focuses on RESTful APIs and a combination of JDBC and ODBC for database integration, other embodiments might employ different integration technologies. For instance, in environments where legacy systems predominate, the integration could rely on SOAP web services or even direct database connections using vendor-specific protocols. In some cases, the system might also integrate with flat-file data sources through secure file transfer protocols like SFTP or FTPS. In all embodiments, the goal of the integration phase is to ensure that the system becomes a seamless part of the organization's IT landscape, capable of intelligently managing workflows by leveraging the comprehensive data and functionalities of the interconnected platforms.

With integration complete, the system's dynamic flow designer allows managers and IT staff to visually create and customize workflows, as indicated in block 306. This user-friendly interface lets users drag and drop different process elements to design workflows that meet their specific needs. The AI utilizes supervised learning techniques to suggest workflow designs based on historical efficiency data and common organizational patterns. In the preferred embodiment, the system's dynamic flow designer is an integral component that provides a graphical user interface (GUI) enabling the intuitive creation and customization of workflows. This GUI could be built using a web framework, which are known for their responsive design and user-friendly interaction capabilities. The flow designer works in tandem with a server-side engine, preferably developed in a language like Java or Python, which provides the necessary computing power to process complex workflow algorithms and manage user sessions.

The designer interface presents a canvas where users can drag and drop predefined process elements, which could include tasks, decision points, and various action nodes. These elements are typically represented by visually distinct icons, making it easier for users to identify and organize them into a coherent workflow sequence. On the backend, each element is backed by a data model that captures its properties and behaviors, stored in a format such as JSON or XML, which the system interprets to execute the workflow logic. Accompanying the dynamic flow designer is an AI-powered recommendation engine. This engine uses supervised learning techniques to analyze historical workflow data and efficiency metrics. By applying machine learning models such as decision trees or neural networks, which could be implemented using libraries like scikit-learn or TensorFlow, the engine can identify patterns and suggest optimal workflow configurations. The AI's suggestions are presented to the user within the flow designer as intelligent prompts, offering options to improve the efficiency of the workflow based on the analysis of past performance and common organizational practices.

The AI's training data is sourced from the organization's historical workflow executions, which are logged and stored in a database system. This training data is periodically updated and enriched with new workflow performance data to refine the AI's predictive capabilities. The machine learning models are retrained in a controlled environment, either on-premises or using cloud-based services, which allows for scalable compute resources to handle the training process. Other embodiments might use different technologies for the flow designer. For instance, a desktop application built with an alternative framework could provide a more integrated experience for users in environments where web access is restricted. Alternatively, for simpler workflow needs, the system could offer a basic template-based configuration without the drag-and-drop capabilities, which would not require as robust a GUI framework. In all cases, the goal of the dynamic flow designer component is to empower users to create and maintain their workflows with ease, aided by AI-driven insights to optimize efficiency and adaptability to the organization's evolving operational landscape.

The system's machine learning component begins an ongoing process of training and refinement, as indicated in block 308. Through techniques such as reinforcement learning and pattern recognition, the AI analyzes the effectiveness of different workflows and user interactions to optimize task prioritization and workflow design. This is a continuous improvement process that ensures the system becomes more intelligent and efficient over time. In a preferred embodiment, the system's machine learning component is engineered to harness the power of reinforcement learning and pattern recognition to create a self-optimizing workflow management system. The core of this component is a robust machine learning pipeline, which could be constructed using a platform like Python with libraries such as TensorFlow for building and training the models, and Pandas for data manipulation and analysis. The pipeline includes several stages: data collection, data preprocessing, model training, model evaluation, and model deployment.

Data collection is facilitated by a data acquisition module that continuously gathers workflow execution data, user feedback, and system logs. This module is crucial for providing the raw material that the AI uses to learn and adapt. Data preprocessing is then performed to clean the data and extract relevant features, using Python scripts that can handle a variety of data formats and sources. Once the data is prepared, it is fed into a reinforcement learning model. This model could be built upon a neural network architecture designed to recognize patterns in workflow executions and user behaviors. The neural network might use a combination of convolutional layers for pattern recognition and long short-term memory (LSTM) layers for understanding the sequential nature of workflows. The model is trained using a reward system that reinforces decisions that lead to increased efficiency, such as reducing the time to complete a task or minimizing the number of steps in a workflow.

Model evaluation is a continuous process, involving both offline metrics such as accuracy, precision, and recall, and online metrics like user satisfaction and engagement. The model is updated and refined iteratively based on these evaluations, with new data continuously incorporated to improve its predictions. In deployment, the trained models are integrated into the workflow system's operational environment. This involves setting up an inference engine, potentially utilizing a scalable cloud service for executing the model's predictions in real-time, or a more traditional server setup for batch processing.

Other embodiments of the system's machine learning component might utilize different techniques or architectures. For example, in simpler scenarios where the workflows are not overly complex, a decision tree algorithm could suffice for pattern recognition tasks, requiring less computational power and simpler infrastructure. Alternatively, for highly dynamic environments, a more complex deep learning architecture could be employed, requiring more robust hardware such as GPUs for training and inference. Regardless of the specific embodiment, the overall aim is to develop a machine learning component that can continually learn from the entity's workflows and user interactions, using these insights to enhance the efficiency and intelligence of the system over time. This creates a virtuous cycle of improvement, ensuring that the workflow system remains up-to-date with the organization's evolving needs.

The AI-driven automated access management system starts to function by detecting approvers' access levels and automating the granting of permissions, as indicated in block 310. Concurrently, a proxy assignment module, utilizing predictive analytics, identifies potential delegation needs and recommends proxy assignees to ensure continuity of work. This step is crucial in proactive task management, especially in preventing bottlenecks due to unavailability of key personnel. For instance, a user may generate a request for IT service which, in conventional systems, would be forwarded on as an incident response report to a team of IT personnel who would be required to review the incident details, pinpoint the specific issue, potentially follow-up with the user for more information, potentially access the user's workstation or virtual desktop for activity reports of the system and its active programs or resource requirements, and may determine that a level of secured access or permissions are required in order to address the issue from the IT personnel side. It is the goal of the workflow management and response system to automate many, if not all of, these steps in order to ensure that the IT personnel instead receives actionable information in a setting where they have been pre-authorized to access the necessary resources to take immediate action.

In a preferred embodiment, the AI-driven automated access management system is crafted to streamline the complex and often time-consuming process of access rights management. At the core of this system lies a sophisticated rule engine, which is programmed with the organization's access policies and is capable of making real-time decisions about permission granting. This engine might be built using a rules management system, which allows for the definition of complex business rules in a format that can be understood and maintained by business analysts, not just IT staff.

The system also includes an identity and access management (IAM) component that interfaces with the rule engine. This IAM component could be built on top of existing solutions such as Keycloak or integrated with enterprise solutions like Active Directory. It maintains a comprehensive record of all employees' roles, access levels, and current permissions. When an IT service request is initiated, the rule engine assesses the request against the stored policies and the IAM data to determine if the IT personnel have the necessary permissions. If they do not, the engine automatically initiates a permission granting process, which might include additional security checks or approvals if required by the organization's policies.

Concurrently, the proxy assignment module employs predictive analytics to anticipate when key personnel might not be available to handle specific tasks or incidents. This module could use a time series forecasting model, implemented via a machine learning library such as models in Python's statsmodels, to predict availability based on historical data regarding leave, workload patterns, and past delegation records. Upon detecting a potential unavailability, the system proactively suggests alternative assignees who have the required skillset and access permissions. These suggestions are based on the model's predictions and are presented to managers or the workflow system for approval, ensuring that there is no delay in incident response due to personnel unavailability.

In other embodiments, the automated access management system and proxy assignment module may employ different technologies or approaches. For instance, in a smaller organization where workflows and access structures are less complex, the system could use a simpler deterministic algorithm for access management and manual input for proxy assignments. Alternatively, in a highly secure environment, the system might integrate with advanced security information and event management (SIEM) systems to incorporate real-time security data into the access management decision-making process. Regardless of the embodiment, the goal of the automated access management system is to ensure that IT personnel receive actionable information and have pre-authorized access to the necessary resources to take immediate action. This effectively reduces the response time to incidents and minimizes the administrative overhead associated with access management and task delegation.

With the workflows, access management, and proxy systems in place, the system deploys a dashboard for end-users, as indicated in block 312. This dashboard is the interface through which employees interact with the system. It displays prioritized tasks, delegated assignments, and real-time alerts. Training sessions are held for all employees to familiarize them with dashboard features, emphasizing how to interpret AI-prioritized tasks and alerts. In a preferred embodiment, the dashboard acts as the central hub for user interaction with the workflow management and response system. It is designed using a modern front-end technology stack, such as Angular or React, paired with robust backend services for high-performance data handling. This dashboard is web-based, ensuring accessibility from a variety of devices within the organization's network. It is securely accessible via the organization's intranet or a secure internet connection, with user authentication managed through various protocols to ensure secure access.

The dashboard's user interface (UI) is constructed to provide a clean, intuitive user experience, with a focus on minimizing cognitive load. Real-time data visualization libraries are integrated to display data in an easily digestible format. The dashboard provides a visual representation of tasks in various states-pending, in-progress, or completed-and uses color coding or other visual cues to indicate priority, based on the AI's recommendations. The backend, which could use RESTful APIs or GraphQL, ensures real-time updates of tasks and alerts without requiring page refreshes, offering a seamless user experience.

For access management, the dashboard interfaces with the system's rule engine and IAM to display current access levels and any pending access requests or automated access adjustments in real time. The proxy assignment module's output is also integrated, showing recommended task delegations and allowing users to confirm or modify these suggestions. The dashboard is designed to be flexible, allowing for customization of views and widgets based on user roles and preferences, which is facilitated by a configuration management API. Training for end-users is developed to include interactive modules and live demonstrations, ensuring that employees are comfortable with navigating the dashboard and understand the significance of AI-driven task prioritization. This training might be supported by e-learning tools or in-person workshops, depending on the organization's scale and training strategy.

Other embodiments might use different technologies for the dashboard. For example, in a scenario where the organization's IT infrastructure is heavily invested in specific proprietary technologies, the dashboard might be developed using a specific client-side framework in accompaniment with additional resources to provide real-time web functionality. In environments where the security of sensitive data is paramount, the dashboard might run on an isolated network segment, with data relayed to it from the workflow management and response system through a secure application gateway. In all cases, the aim is to provide a user-friendly dashboard that serves as a one-stop interface for all workflow-related interactions, tailored to provide the necessary information and controls to support efficient task and access management across the organization.

The system then enters a phase of continuous monitoring, as indicated in block 314. Using real-time analytics, the system tracks workflow efficiency, task completion rates, and user engagement. This data feeds into the AI models, which apply unsupervised learning techniques to detect patterns and anomalies, thereby offering insights for further system optimization. In a preferred embodiment, the continuous monitoring phase is facilitated by a comprehensive analytics engine that is an extension of the workflow management and response system. This engine is composed of several key components: a data streaming service, which captures real-time workflow events; a time-series database, optimized for storing and retrieving time-stamped data; and an analytics processing unit, which can perform complex analytics operations on streaming data.

The analytics engine is tasked with collating data from various touchpoints within the workflow process, including start and end times of tasks, user interactions, and system-generated alerts. This data is processed in real-time, enabling the system to provide immediate feedback on workflow efficiency and task completion rates. The user engagement metrics, which could be gathered through integrated monitoring tools within the dashboard UI, are tracked to understand how users interact with the system and identify potential areas for user interface or user interface design improvements.

The AI models that are part of this monitoring phase use unsupervised learning techniques, such as clustering and neural networks, to analyze the collected data. These models are built and maintained using machine learning frameworks like scikit-learn or TensorFlow, depending on the complexity of the data patterns. The unsupervised algorithms are designed to identify anomalies that might indicate inefficiencies or bottlenecks in the workflows and to detect emerging patterns that could suggest new optimization opportunities. The models are retrained periodically with new data to ensure their accuracy remains high. In other embodiments, the continuous monitoring phase could be implemented using different technologies. For instance, an organization with less stringent real-time requirements might opt for a simpler batch processing setup to schedule periodic data collection and analysis. Alternatively, a company with existing business intelligence infrastructure could integrate the workflow management and response system with tools for analytics and monitoring, leveraging their powerful data visualization capabilities.

Regardless of the specific technologies used, the continuous monitoring phase is critical for maintaining an efficient workflow system. It provides the necessary insights to inform ongoing system optimization, ensuring that the workflow management and response system adapts to changing organizational needs and maintains optimal performance over time.

The final step is the establishment of a feedback loop, as indicated in block 316. Users provide feedback on the system's functionality, which is combined with the analytics data to fine-tune the AI models and workflow designs. This iterative process ensures that the system evolves to meet changing organizational demands, with the machine learning component adjusting to new data, user behaviors, and feedback to deliver a refined, efficient workflow experience continuously. In a preferred embodiment, the feedback loop is a critical mechanism designed to harness user insights and analytics data to enhance the workflow management and response system. This feedback loop is facilitated by a combination of software components including a feedback capture tool, data analysis software, and the AI model training environment.

The feedback capture tool could be a simple web form or a more complex system like a Customer Relationship Management (CRM) platform that allows users to log their experiences, issues, and suggestions while using the system. This tool could be integrated directly into the system dashboard for ease of access. The collected feedback is stored in a central repository, which could be a relational database management system (RDBMS) like PostgreSQL or a NoSQL database like MongoDB, depending on the structure and volume of feedback data.

Data analysis software, which could be part of the aforementioned analytics engine, processes this feedback along with operational data captured during workflow execution. This might involve natural language processing (NLP) algorithms to categorize and quantify qualitative feedback, and statistical analysis tools to identify trends and correlations in quantitative feedback and usage data. The processed feedback and analytics data are then used to fine-tune the AI models. This could involve retraining the models with new data to adjust to changes in workflow patterns or user behavior. Machine learning platforms like TensorFlow, Keras, or PyTorch provide the necessary libraries and APIs for model retraining, while cloud-based services offer scalable environments for training and deploying these models.

Other embodiments of the feedback loop might utilize different technologies or methods. For example, in a smaller organization, feedback might be collected and reviewed manually, with insights being used to directly adjust workflow configurations without the need for complex AI model retraining. Alternatively, in a highly regulated industry, feedback and data analysis might be subjected to stricter compliance checks before being used to alter system behavior. Regardless of the specific technologies employed, the feedback loop is an essential component of the system, ensuring that the workflow management and response system remains dynamic and responsive to the users' needs. This ongoing iterative process of collecting feedback, analyzing data, and adjusting AI models and workflow configurations is what allows the system to continuously improve and adapt to the evolving demands of the organization.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for optimizing workflow management and response systems in a distributed network, the system comprising:
a processing device;
a non-transitory storage device containing instructions when executed by the processing device, causes the processing device to perform the steps of:
integrating with a plurality of enterprise systems through application programming interfaces (APIs) to aggregate workflow task data;
receiving, via a data acquisition module, workflow-related data from the plurality of enterprise systems;
storing the workflow-related data in a time-series database for subsequent retrieval and analysis;
employing a machine learning engine to analyze the workflow-related data to detect patterns, anomalies, and inefficiencies and storing the patterns, the anomalies, and the inefficiencies as historical efficiency data;
applying a reinforcement learning algorithm to adjust a task prioritization within a workflow based on real-time analytics and the historical efficiency data;
automating access management by dynamically assigning and adjusting user permissions and access levels within the plurality of enterprise systems based on predefined security policies and real-time workflow requirements;
predicting, via the machine learning engine, delegation needs and recommending proxy assignees using the reinforcement learning algorithm; and
presenting a dashboard to end-users displaying prioritized tasks, delegated assignments, real-time alerts, and actionable insights derived from a machine learning engine analysis.

2. The system of claim 1, wherein employing the machine learning engine further comprises utilizing an unsupervised learning algorithm.

3. The system of claim 1, wherein the system is further configured to: execute a feedback module configured to capture user feedback regarding system functionality and workflow efficiency.

4. The system of claim 3, wherein the system is further configured to: retrain the machine learning engine using captured user feedback and the analytics data to refine the machine learning engine.

5. The system of claim 1, wherein the system is further configured to: update a dynamic flow designer tool based on a retrained machine learning engine to reflect an optimized workflow path.

6. The system of claim 1, wherein the system is further configured to:
generate a report and alert based on the analysis performed by the machine learning engine; and
provide the report and the alert via the APIs.

2. The system of claim 1, wherein the system is further configured to: utilize a data streaming service to capture and process workflow events as they occur, facilitating an immediate identification and response to workflow incidents.

8. A computer program product for optimizing workflow management and response systems in a distributed network, the computer program product comprising a non-transitory computer-readable medium comprising code causing an apparatus to perform the steps of:
integrating with a plurality of enterprise systems through application programming interfaces (APIs) to aggregate workflow task data;
receiving, via a data acquisition module, workflow-related data from the plurality of enterprise systems;
storing the workflow-related data in a time-series database for subsequent retrieval and analysis;
employing a machine learning engine to analyze the workflow-related data to detect patterns, anomalies, and inefficiencies and storing the patterns, the anomalies, and the inefficiencies as historical efficiency data;
applying a reinforcement learning algorithm to adjust a task prioritization within a workflow based on real-time analytics and the historical efficiency data;
automating access management by dynamically assigning and adjusting user permissions and access levels within the plurality of enterprise systems based on predefined security policies and real-time workflow requirements;
predicting, via the machine learning engine, delegation needs and recommending proxy assignees using the reinforcement learning algorithm; and
presenting a dashboard to end-users displaying prioritized tasks, delegated assignments, real-time alerts, and actionable insights derived from a machine learning engine analysis.

9. The computer program product of claim 8, wherein employing the machine learning engine further comprises utilizing an unsupervised learning algorithm.

10. The computer program product of claim 8, wherein the code further causes the apparatus to: execute a feedback module configured to capture user feedback regarding system functionality and workflow efficiency.

11. The computer program product of claim 10, wherein the code further causes the apparatus to: retrain the machine learning engine using captured user feedback and the analytics data to refine the machine learning engine.

12. The computer program product of claim 8, wherein the code further causes the apparatus to: update a dynamic flow designer tool based on a retrained machine learning engine to reflect an optimized workflow path.

13. The computer program product of claim 8, wherein the code further causes the apparatus to:
generate a report and alert based on the analysis performed by the machine learning engine; and
provide the report and the alert via the APIs.

14. The computer program product of claim 8, wherein the code further causes the apparatus to: utilize a data streaming service to capture and process workflow events as they occur, facilitating an immediate identification and response to workflow incidents.

15. A method for optimizing workflow management and response systems in a distributed network, the method comprising:
integrating with a plurality of enterprise systems through application programming interfaces (APIs) to aggregate workflow task data;
receiving, via a data acquisition module, workflow-related data from the plurality of enterprise systems;
storing the workflow-related data in a time-series database for subsequent retrieval and analysis;
employing a machine learning engine to analyze the workflow-related data to detect patterns, anomalies, and inefficiencies and storing the patterns, the anomalies, and the inefficiencies as historical efficiency data;
applying a reinforcement learning algorithm to adjust a task prioritization within a workflow based on real-time analytics and the historical efficiency data;
automating access management by dynamically assigning and adjusting user permissions and access levels within the plurality of enterprise systems based on predefined security policies and real-time workflow requirements;
predicting, via the machine learning engine, delegation needs and recommending proxy assignees using the reinforcement learning algorithm; and
presenting a dashboard to end-users displaying prioritized tasks, delegated assignments, real-time alerts, and actionable insights derived from a machine learning engine analysis.

16. The method of claim 15, wherein employing the machine learning engine further comprises utilizing an unsupervised learning algorithm.

17. The method of claim 15, wherein the method further comprises: executing a feedback module configured to capture user feedback regarding system functionality and workflow efficiency.

18. The method of claim 17, wherein the method further comprises: retraining the machine learning engine using captured user feedback and the analytics data to refine the machine learning engine.

19. The method of claim 15, wherein the method further comprises: updating a dynamic flow designer tool based on a retrained machine learning engine to reflect an optimized workflow path.

20. The method of claim 15, wherein the method further comprises:
generating a report and alert based on the analysis performed by the machine learning engine; and
providing the report and the alert via the APIs.
